(19) United States
(12) Patent Application Publication
(10) Pub. No.: US 2021/0309460 A1
(43) Pub. Date: Oct. 7, 2021

(54) WAREHOUSE MANAGEMENT METHOD AND SYSTEM

(71) Applicant: MOTION2AI, Mountain View, CA (US)

(72) Inventors: Byungsoo KIM, Palo Alto, CA (US); Brian J. SOHN, Redmond City, CA (US)

(73) Assignee: MOTION2AI, Mountain View, CA (US)

(21) Appl. No.: 17/353,227

(22) Filed: Jun. 21, 2021

Related U.S. Application Data
(63) Continuation of application No. PCT/US2019/067999, filed on Dec. 20, 2019.
(60) Provisional application No. 62/784,078, filed on Dec. 21, 2018.

(51) Int. Cl. B65G 1/137; B65G 1/04; G05D 1/02

(52) U.S. Cl. CPC B65G 1/1373; B65G 1/0421; G05D 1/0289; G05D 1/0246; G05D 2201/0216; B65G 2203/0258; B65G 2203/0283; B65G 2203/041; G05D 1/0274

(57) ABSTRACT

Present disclosure relates to a method, control device, and a work device, for managing a plurality of work devices having a plurality of sensors, in a warehouse. The method includes at least: collecting information on the warehouse; analyzing the collected information; generating instructions based on the analyzed information; transmitting the generated instructions to work devices. The generated instructions include instructions for controlling at least one of a priority order of works to be performed by the work devices and a working route of the work devices in the warehouse.

### CROSS-REFERENCE TO RELATED APPLICATIONS

The present application is a continuation of International Patent Application No. PCT/US2019/067999, filed on Dec. 20, 2019, which claims priority based on provisional application No. 62/784,078, filed on Dec. 21, 2018, the contents of which is incorporated by reference in their entireties.

### BACKGROUND

A warehouse may be used for storage of items by a variety of different types of commercial entities, including manufacturers, wholesalers, and transport businesses. Example stored items may include raw materials, parts or components, packing materials, and finished products.

Any business that uses such items is engaged in some form of warehouse management to provide solutions for keeping operations running efficiently, remaining competitive in the marketplace and meeting their budget goals.

With constant pressure to reduce the total cost, protect driver safety, minimize risks and increase productivity, such businesses are looking to use automated devices and software that can help them confront the numerous business challenges they face.

In some situations, the warehouse may use machines or vehicles for lifting and moving items, such as cranes and forklifts. Human operators may be employed to operate machines, vehicles, and other equipment. In some cases, one or more of the machines or vehicles may be robotic devices guided by computer control systems.

A centralized system may store information on the warehouse, such as the number of items on the storage, type of item, dimension and weight of item, and location of the item within the warehouse. The centralized system may include similar information for all items located in the warehouse, such that the centralized system contains an inventory of the warehouse.

In this circumstance, a warehouse operator needs more efficient system to manage the warehouse storing a number of items to be handled by a number of work devices. Sometimes, it is prohibitively expensive and time consuming for managing the warehouse storing a number of items.

### SUMMARY

It is an object of the present disclosure to provide a method, control device, and a work device, for managing a plurality of work devices having a plurality of sensors, in a warehouse.

In some embodiments, a method for managing a warehouse, performed by a system including a plurality of sensors is provided. The method includes at least: collecting information on the warehouse; analyzing the collected information; generating instructions based on the analyzed information; transmitting the generated instructions to work devices. The generated instructions include instructions for controlling at least one of a priority order of works to be performed by the work devices and a working route of the work devices in the warehouse.

In some embodiments, a control device is provided. The control device includes a processor and a memory coupled with the processor. The processor of the control device is configured to: collect information on the warehouse; analyze the collected information; generate instructions based on the analyzed information; transmit the generated instructions to work devices. The generated instructions include instructions for controlling at least one of a priority order of works to be performed by work devices and a working route of the work devices.

In some embodiments, a work device is provided. The work device includes a processor and a memory coupled with the processor. The processor of the work device is configured to: collect information on the warehouse; transmit the collected information to a control system; receive instructions from the control system; and execute the received instructions. The received instructions include instructions for controlling at least one of a priority order of works to be performed by the work device and a working route of the work device.

Other specific details of the present disclosure are included in the detailed description and drawings.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a schematic diagram illustrating a warehouse management system according to some embodiments of the present disclosure;

FIG. 2 is a flow chart illustrating a method for managing a warehouse according to some embodiments of the present disclosure;

FIG. 3 is a block diagram illustrating a warehouse management device according to some embodiments of the present disclosure;

FIG. 4 is a block diagram illustrating a work device according to some embodiments of the present disclosure;

FIG. 5 is a schematic figure illustrating a sensor of a work device according to some embodiments of the present disclosure;

FIGS. 6A and 6B are schematic figures illustrating recognitions of objects from images according to some embodiments of the present disclosure;

FIG. 7 is a schematic overview diagram illustrating data flows in a warehouse management system according to some embodiments of the present disclosure;

FIGS. 8-17 are schematic user interfaces of a warehouse management application according to some embodiments of the present disclosure; and

FIGS. 18-23 are schematic user interfaces of a warehouse management application according to some embodiments of the present disclosure.

### DETAILED DESCRIPTION

Advantages and features of embodiments of the inventive concept, and method for achieving them will be apparent with reference to the accompanying drawings and detailed description that follows. But, it should be understood that the inventive concept is not limited to the following embodiments and may be embodied in different ways, and that the embodiments are given to provide complete disclosure of the inventive concept and to provide thorough understanding of the inventive concept to those skilled in the art, and the scope of the inventive concept is limited only by the accompanying claims and equivalents thereof.

The terms used in the present disclosure are provided to describe embodiments, not intended to limit the inventive concept. In the present disclosure, singular forms are intended to include plural forms unless the context clearly indicates otherwise. It will be further understood that the terms “comprises,” and/or “comprising,” used herein, specify the presence of stated elements, but do not preclude the presence or addition of one or more other elements. In the present disclosure, like reference numerals indicate like elements, and the term “and/or” indicates each of the listed components or various combinations thereof. Terms, such as “first,” “second,” and the like, are for discriminating various components. However, the scope is not limited to the above terms. The above terms are used for discriminating one component from another component. Therefore, the first component mentioned below may be the second component within the technical spirit of the inventive concept.

Unless otherwise defined, all terms used herein (including technical or scientific terms) have the same meanings as those generally understood by those ordinarily skilled in the art to which the inventive concept pertains. Such terms as those defined in a generally used dictionary are not to be interpreted as having ideal or excessively formal meanings unless defined clearly and specifically.

Hereinafter, embodiments of the inventive concept will be described in detail with reference to the accompanying drawings.

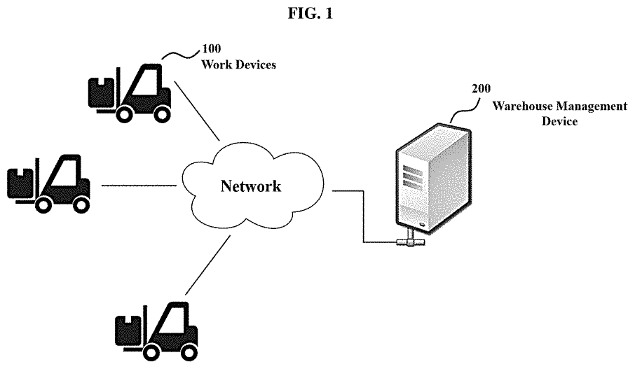

FIG. 1 is a schematic diagram illustrating a warehouse management system according to some embodiments of the present disclosure.

As shown in FIG. 1, in some embodiments, the warehouse management system includes a plurality of work devices 100 and a warehouse management device 200 connected with the plurality of work devices 100 via a network.

In FIG. 1, the work devices 100 are shown as forklifts. However, it will be understood that this invention is not intended to be limited to the illustrated forklifts, because many other types of vehicles and devices are contemplated by this disclosure. In some embodiments, the work devices 100 can be any machines or vehicles being operated in the warehouse. For example, machines or vehicles for lifting and moving goods or pallets of goods, such as cranes, forklifts, robot arms and pallet jacks can be included in the warehouse management system as the work devices 100. Human operators may be employed to operate the work devices 100. In some cases, one or more of the work devices 100 may be robotic devices guided by computer control systems.

In addition, a network connectable device may be basically provided in the work devices 100, but according to some embodiments, such a network connectable device may be detachable to the work devices 100. For example, by integrating a smart device (e.g., smartphone) having a processor and a memory can be coupled with the work devices 100 so that the work devices 100 can communicate with the network to perform an operation according to the features described in the present disclosure.

In FIG. 1, the warehouse management device 200 is illustrated as a server device. However, it will be understood that this invention is not intended to be limited to the illustrated server device, because many other types of control device is contemplated by this disclosure. In some embodiments, the warehouse management device 200 can be any device including a processor and a memory. For example, a personal computer (PC) or a smart device (e.g. smartphone) may serve as the warehouse management device 200.

In FIG. 1, the network is illustrated. In some embodiments, the network may be Internet network. In some other embodiments, the network may be Intranet network to improve security. Meanwhile, in yet another embodiments, the network may be a method using wireless communication means such as Bluetooth, Wi-Fi, Zigbee, Wi-Max, GPRS, GSM, Wibree but not limited to it.

Further detailed configurations and operations of the warehouse management system will be described with reference to the following drawings.

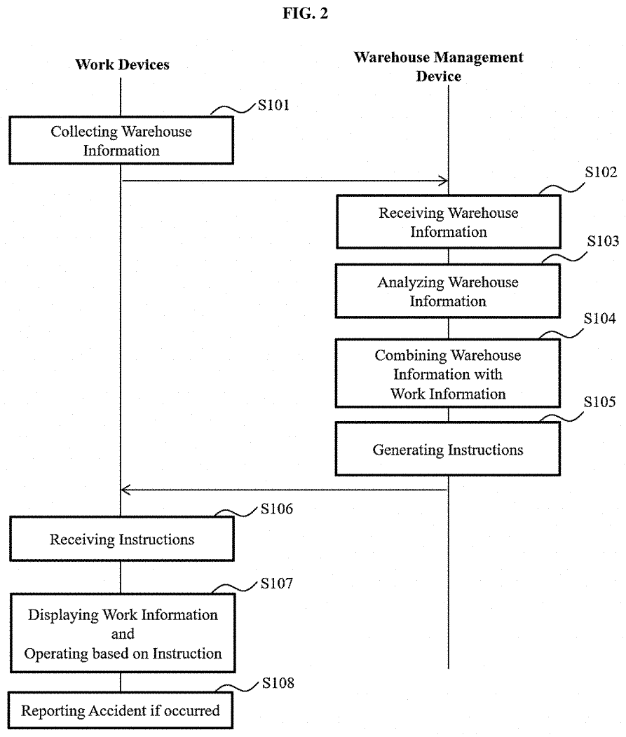

FIG. 2 is a flow chart illustrating a method for managing a warehouse according to some embodiments of the present disclosure.

In some embodiments, a warehouse management device 200 performs steps shown in FIG. 2 for managing a warehouse.

A management begins, at step S101, with that work devices 100 collect warehouse information.

The work devices 100 collect image information by using an image sensor (e.g., camera) included in a respective work device. Various sensors can be configured to receive image and video data, such as stereo cameras, depth sensors, LIDARs, Radars, and/or infrared sensors, among other possibilities. The sensor may have a limited field of view. Consequently, the sensor may be connected to the work devices 100 through a pan-head, one or more rotational joints, and/or one or more translational motion mechanisms to allow the sensor to rotate and/or translate with respect to the work devices 100 to control a portion of the environment within the field of view of the sensor. In some embodiments, to overcome the limited field of view, a combination of a wide ceiling camera and a wide forward camera can be configured as the image sensor.

In some embodiments, the work devices 100 collect the warehouse information as they are moving in the warehouse. In some embodiments, the work devices 100 may receive instructions, from the warehouse management device 200, for moving to a location where more warehouse information is necessary. For example, the work device 100 may be instructed to move to a location having newly stored items and/or a location where no warehouse information is ever collected. According to this, the warehouse management device 200 may collect sufficient information to manage the warehouse.

The work devices 100 transmits, via a network, the collected information to a warehouse management device 200. As aforementioned, a variety of types of communication methods may be utilized in communication between the work devices 100 and the warehouse management device 200.

At step S102, the warehouse management device 200 receives the warehouse information transmitted from the work devices 100.

In some embodiments, the warehouse management device 200 may store the received warehouse information in a non-transitory storage medium, which is included in the warehouse management device 200.

At step S103, the warehouse management device 200 analyzes the received warehouse information.

In some embodiments, the warehouse management device 200 may identify a location of a respective item located in the warehouse by analyzing the collected information, and identify a dimension and weight of a respective item located in the warehouse by analyzing the collected information.

Various algorithms can be employed by the warehouse management device 200 to analyze the received warehouse information, such as a generative model algorithm, a non-linear hierarchical algorithm, or a convolutional neural network, or a recurrent neural network, or a deep belief network, or a dictionary learning algorithm, or a parameter, or a mapping function.

The analysis may include detecting objects, such as parcels, human bodies, vehicles, or other objects, located in the warehouse, by using images and/or videos collected by the work devices 100. In an example, deformable part-based models of Histogram of Oriented Gradients (HOG) features, such as combined with latent Support Vector Machines (SVM) techniques, can be used to analyze the received warehouse information. In an example, part-based detection methods can be used to localize various portions of objects, such as identification label parts of items, in an image. In some embodiments, the warehouse management device 200 may analyze images by using model training. T raining can be an offline step where machine learning algorithms (such as a convolutional neural network) are trained on a training data set to learn object forms, such as non-human forms or human forms, from various images. Detection methods can use one or more machine learning models to classify objects or regions in an image or frame.

In some embodiments, the above-described acquisition of surrounding 3D geometry may be performed through Visual Simultaneous Localization and Mapping (SLAM), followed by projection of Convolutional Neural Network semantic perception of items and racks.

At step S104, the analyzed warehouse information may be combined with work information, which can be received, in real-time, from a cloud server or from an Enterprise Resource Planning (ERP). Thus, the warehouse can be managed not only based on the information collected by work devices but also based on the information transmitted from other external control entities.

At step S105, the warehouse management device 200 generates, based on the combined information, instructions for managing the warehouse.

In some embodiments, the instructions may include instructions for controlling moving items, loading/unloading items on trucks, and/or loading/unloading items on storage shelves.

In some embodiments, the instructions may include instructions for controlling a priority order of works to be performed by the work devices 100. In some embodiments, the instructions are instructions for controlling a working route of the work devices in the warehouse. The instructions may be generated based on distances from the work devices 100 to items to be handled, weights of items, dimensions of items, and work routes of work devices 100.

In some embodiments, the priority order of works (i.e., work orders) are determined based on a variety of types of data including real-time locations of packages, vehicles, and big data about details of packages and vehicles. In some embodiments, such data is firstly converted into a fixed-size feature space. In some embodiments, the mapping between features and the final work orders are trained through machine learning framework such as reinforcement learning and imitative learning.

In some embodiments, the warehouse management device 200 may generate instructions for control a work device 100 to first move an item located in the closet position from a location of the work device 100, and to next mode an item located in the second closet position from the location of the work device 100.

As another example, the warehouse management device 200 may generate instructions for control work devices 100 to have no or less conflicts and interferences between work routes of the work devices 100. This can be performed based on a floorplan of the warehouse.

The work routes may include predetermined paths for the work devices 100 in the warehouse.

The aforementioned algorithm has an advantage of running in real-time; in other words, re-routing in real-time can be provided with the aforementioned algorithm.

The warehouse management device 200 may transmit, via the network, the generated instructions to the work devices 100.

At step S106, the work devices 100 receive the instructions transmitted from the warehouse management device 200.

In some embodiments, the work devices 100 may store the received instructions in a non-transitory storage medium, which is included in the work devices 100.

At step S107, the work devices 100 displays work information based on the received instruction. Also, the work devices 100 operates in accordance with the received instruction.

In some embodiments, the work devices 100 display, at a respective work device, navigation information including route information and working order information, based on the generated instructions.

The work devices 100 may operate in accordance with the work routes included in the instruction. The work routes may include predetermined paths for the work devices 100 in the warehouse. In some embodiments, the work devices 100 may determine or modify the paths based on sensing data, and/or a previous task or operation commanded to the work devices 100.

Although it is not shown in FIG. 2, the warehouse management device 200, in some embodiments, communicates with the work devices 100 to collect work status information of the work devices 100, and display a utilization rate of a respective work device.

At step S108, if the work devices 100 detect any accident, the work devices 100 reports, via the network, to the warehouse management device 200, an occurrence of the accident.

The accident may include a variety of abnormal situations. For example, a crash between work devices 100, a crash between a work device 100 with other objects, a conflict of work instructions, an engine malfunction, etc. The work devices 100 may detect the accident based on status information in the form of acceleration, velocity, and/or impact direction, based on information collected by sensors of the work devices 100. To estimate a level of the accident, the work devices 100 may analyzes one or more aspects of the status information. In some embodiments, the work devices 100 calculates an estimate of the work device damage by comparing the status information to collision data of a device type that includes the damaged device. The collision data may include various levels of device damage associated with specified aspects of collision information. For example, one category of device damage in the collision data may be equated to a particular device acceleration or velocity, or a range of vehicle accelerations or velocities. Other categories of device damage in the collision data may also be equated to a device direction, which indicates where the damaged device was likely impacted. Based on the extent of device damage estimated by the comparison of the status information to the collision data, the work devices 100 determine a treatment complexity level for treating the damaged device. Thereafter, information related to treating the damaged vehicle is then transmitted by the system. The treatment information may be sent to the warehouse management device 200. As such, the warehouse management system allows for work devices 100 damaged in the accident to be properly treated. In some other embodiments, the above-described usage of sensing information in the accident may be performed by the warehouse management device 200 that receives such sensing information.

In some other embodiments, the above-describe accident may include a situation that a vehicle crashes with other vehicle or infrastructure. In such a situation, a sensor fusion algorithm uses IMU sensor streaming data and camera real-time video stream to determine the cause of accident and its damages.

In some embodiments, the warehouse management device 200 modifies the instructions in response to a report of an accident, and transmits the modified instructions to the work devices 100.

In some example implementations of the present disclosure, the method of FIG. 2 may be implemented by a management web-based application. For example, the management web-based application may be used in the following orders.
1. Manager (a user of the management web-based application) may open a browser such as Chrome and launch the management web-based application.
2. Manager may log in to his/her Warehouse Management System (WMS)/Enterprise Resource Planning (ERP) account to access work orders and associated information.
3. Manager may select a particular warehouse and its location.
4. Manager may choose to view the warehouse layout either in 2D or in 3D.
5. When 3D is selected, a 3-dimensional representation of warehouse is loaded in the application.
6. Manager may see Forklift symbols moving around in a 2D or 3D representation of a warehouse.
7. Manager may change a zoom level of the view.
8. Manager may use manipulation tools such as pan, rotate and scale to customize their viewing options.
9. Manager may see 3-dimensional representation of warehouse racks identifies the storage bin using numbers from naming schema in WMS/ERP system.
10. Manager may start and end markers to show the forklift origin and destination.
11. Manager may check an optimal navigation route proposed by the warehouse management system and the route followed by operator.

In some other example implementations of the present disclosure, the method of FIG. 2 may be implemented by a work device operator application. For example, the work device operator application may be used in the following orders.
1. Operator (a user of the work device operator application) may get email and inside the application alert when a work order is assigned to him/her.
2. Operator may see work orders in an order of priority.
3. Upon selecting a work order to start working, Operator may see details such as work order status, work order type, job type, item description, item type, storage bin number, etc.
4. Operator may see information regarding which forklift truck is assigned to he/she for use.
5. Operator may scan his/her badge to activate the forklift (provided forklift is card enabled).
6. Operator may have an option to navigate to the storage location in Google maps style navigation that works indoors.
7. While performing the job, Operator may get alerts to change route in case of heavy traffic or slowdown in their current route inside a warehouse.
8. Upon completing the job, Operators may scan an item using RF device and the item information is updated in the WMS system. Service provider system may also get an update from WMS and reflects the update. For example, when work order is completed, the application will show that status.

Further detailed configurations and operations of the warehouse management system will be described with reference to the following drawings.

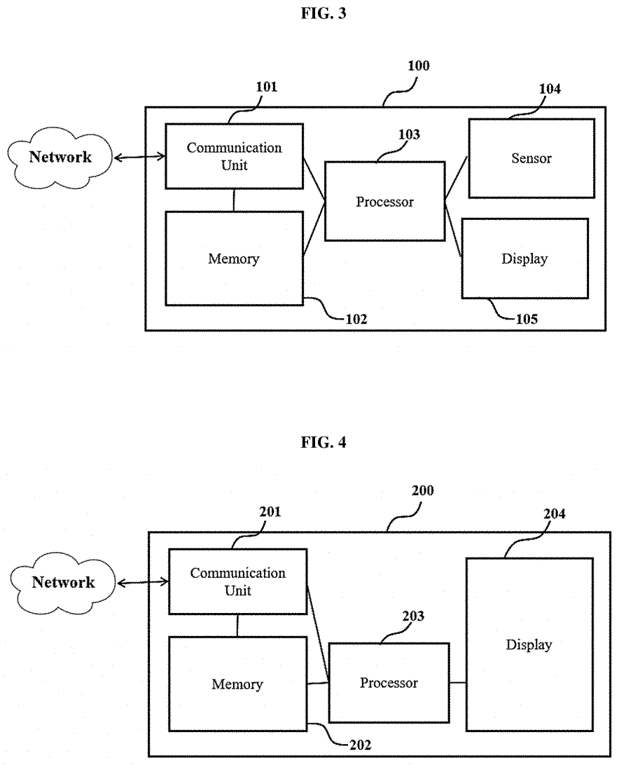

FIG. 3 is a block diagram illustrating a warehouse management device according to some embodiments of the present disclosure.

In some embodiments, a work device 100 includes a communication unit 101, a memory 102, a processor 103, at least one sensor 104, and a display 105.

The communication unit 101 may communicate with external devices (e.g., a warehouse management device 200), via a network. In some embodiments, the communication unit 101 is capable of performing a close range wireless (or radio) communication with other devices. In some embodiments, communication unit 101 is compatible with various telecommunication standards, including Bluetooth, RFID (Radio Frequency Identification), IrDA (Infrared Data Association), UWB (Ultra-Wideband), ZigBee, DLNA (Digital Living Network Alliance).

In some embodiments, the communication unit 101 provides an interface for connecting the work device 100 to a wired/wireless network including Internet network. In some embodiments, the communication unit 101 is provided with an Ethernet terminal. In some embodiments, in a wireless network, the communication unit 101 is compatible with different telecommunication standards including WLAN (Wireless LAN) (Wi-Fi), Wi-bro (Wireless broadband), Wi-max (World Interoperability for Microwave Access), HSDPA (High Speed Downlink Packet Access).

In some embodiments, the communication unit 101 is connected to the warehouse management device 200 via the network. More specifically, the communication unit 101 may transmit sensing data to the warehouse management device 200 via the network and receive instructions from the warehouse management device 200 via the network.

In some embodiments, the memory 102 stores data to be used for managing warehouse and controlling work devices. For example, the memory 102 stores the sensing data sensed by the sensor 104, and also stores instructions received from the warehouse management device 200.

In some embodiments, the memory 102 is a non-transitory storage medium, such as magnetic disks, optical disks, or tape. The memory 102 includes volatile and nonvolatile, removable and non-removable media implemented in any method or technology for storage of information, such as computer readable instructions, data structures, program modules, or other data. The memory 102 includes, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which is used to store information and which is accessed by a processor 103.

The processor 103 controls the overall operation of each component of the work device 100. The processor 103 may be a central processing unit (CPU), a microprocessor unit (MPU), a microcontroller unit (MCU), an application specific integrated circuit (ASIC), a field programmable gate array (FPGA), or any processor well known in the art to which the inventive concept pertains. In addition, the processor 103 may perform an operation on at least one application or program for executing methods according to embodiments.

More specifically, in some embodiments, the processor 103 of the work device 100 is configured to collect information on the warehouse by using at least one sensor 104, transmit the collected information to a control system by using the communication unit 101, receive instructions from the warehouse management device 200 by using the communication unit 101, execute the received instructions to control other parts of the work device 100. In some embodiments, the received instructions include instructions for controlling at least one of a priority order of works to be performed by the work device 100 and a working route of the work device 100. The working route includes a moving route of the work device 100.

The sensor 104 is also included in the work device 100. The at least one sensor 104 may be an image sensor (e.g., camera) that collects image information of a warehouse. Various sensors can be configured to receive image and video data, such as stereo cameras, depth sensors, LIDARs, Radars, and/or infrared sensors, among other possibilities. In addition, other types of sensors, such as a geomagnetic sensor, a gyro sensor, and an acceleration sensor may also be included in the work device 100 to collect warehouse information.

In some embodiments, the information collected by the sensor 140 is used to identify a dimension and weight of a respective item located in the warehouse.

In some embodiments, the information collected by the sensor 140 is used to detect an accident. Information of the detected accident may be transmitted to the warehouse management device 200 by using the communication unit 101.

A display 105 is also included in the work device 100. The display may include an output means such as a display module, a speaker module, or a haptic module. The display may be provided in any form, for example, a plasma display panel (PDP), a liquid crystal display (LCD), a thin film transistor LCD (TFT LCD), an organic light emitting diode (OLED), a flexible display, a three-dimensional (3D) display, or an electronic-link (e-link) display.

In some embodiments, the display 105 displays navigation information including route information and working order information, based on instructions received from the warehouse management device 200.

In some embodiments, as a part of the initial setup to make algorithm controlling run smoothly, a point cloud map is created by moving the work devices 100 inside the warehouse and capturing the environment of the warehouse. Once a facility map is created, it is used by a localization engine to recognize precise location of the work devices 100 inside the warehouse. The facility map may be annotated to mark landmarks such as aisles, palettes and storage bin locations. Landmark annotations of the map may be used by the warehouse management device 200 to navigate the work devices 100 towards a destination.

The various distinctive characteristics and technological ideas, described with reference to FIG. 2, can be realized as being in the form of software, hardware, firmware, middleware or a combination of them. For example, a program for realizing a method for managing a warehouse, which is stored in a computer-readable medium (which is executed by a computer or a controller including a processor), includes one or more program codes and sections that perform various tasks. The program codes executed by the processor 103.

In some embodiments, the work device 100 further includes input device such as a keyboard, a mouse, a pen, a sound input device, a touch input device, etc., and output device(s) such as a display, speakers, a printer, etc.

In some embodiments, the input device may receive a user input to modify the generated instruction for controlling the work device 100.

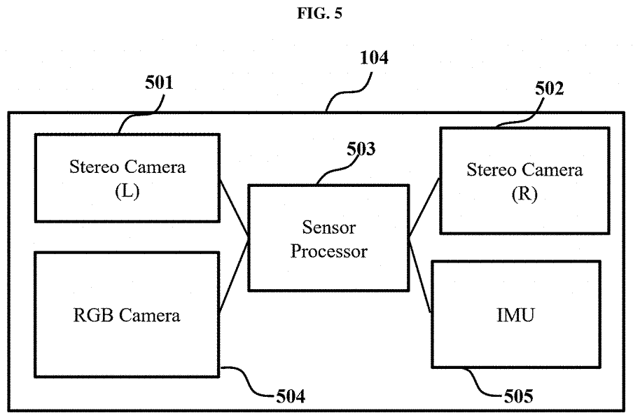

In some embodiments, the work device 100 shown in FIG. 3 and described above may be an integral part of a work vehicle, such as a forklift. Alternatively, in some other embodiments, the work device 100 shown in FIG. 3 and described above may be a detachable part to the work vehicle. For example, the work device 100 may be a smart device (e.g., smartphone) including the communication unit 101, the memory 102, the processor 103, the at least one sensor 104, and the display 105, and configured to be coupled with the work vehicle so that the work vehicle can be controlled based on instructions received from the warehouse management device 200. An exemplarily detachable device is shown in FIG. 5, which is described in below.

The location on the work vehicle where the detachable work device 100 is attached does not matter as long as clear view from a sensor of the work device 100 is secured. It can be attached at front, at the back, or a the side of the work vehicle.

FIG. 4 is a block diagram illustrating a work device according to some embodiments of the present disclosure.

In some embodiments, a warehouse management device 200 includes a communication unit 201, a memory 202, a processor 203, and a display 204. The warehouse management device 200 may be referred as a control device.

The communication unit 201 may communicate with external devices (e.g., a work device 100), via a network. In some embodiments, the communication unit 201 is capable of performing a close range wireless (or radio) communication with other devices. In some embodiments, communication unit 201 is compatible with various telecommunication standards, including Bluetooth, RFID (Radio Frequency Identification), IrDA (Infrared Data Association), UWB (Ultra-Wideband), ZigBee, DLNA (Digital Living Network Alliance).

In some embodiments, the communication unit 201 provides an interface for connecting the warehouse management device 200 to a wired/wireless network including Internet network. In some embodiments, the communication unit 201 is provided with an Ethernet terminal. In some embodiments, in a wireless network, the communication unit 101 is compatible with different telecommunication standards including WLAN (Wireless LAN) (Wi-Fi), Wi-bro (Wireless broadband), Wi-max (World Interoperability for Microwave Access), HSDPA (High Speed Downlink Packet Access).

In some embodiments, the communication unit 201 is connected to the work device 100 via the network. More specifically, the communication unit 201 may receive sensing data generated by the work device 100 and transmit instructions for controlling the work device 100, via the network. In some embodiments, the sensing data include image information collected by an image sensor included in a respective work device 100.

In some embodiments, the memory 202 stores data to be used for managing warehouse and controlling work devices. For example, the memory 202 stores the sensing data received from the work device 100, and also stores instructions generated based on the sensing data.

In some embodiments, the memory 202 is a non-transitory storage medium, such as magnetic disks, optical disks, or tape. The memory 202 includes volatile and nonvolatile, removable and non-removable media implemented in any method or technology for storage of information, such as computer readable instructions, data structures, program modules, or other data. The memory 102 includes, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which is used to store information and which is accessed by a processor 203.

The processor 203 controls the overall operation of each component of the warehouse management device 200. The processor 203 may be a central processing unit (CPU), a microprocessor unit (MPU), a microcontroller unit (MCU), an application specific integrated circuit (ASIC), a field programmable gate array (FPGA), or any processor well known in the art to which the inventive concept pertains. In addition, the processor 203 may perform an operation on at least one application or program for executing methods according to embodiments.

More specifically, in some embodiments, the processor 203 of the warehouse management device 200 is configured to collect information on the warehouse by using the communication unit 201, analyze the collected information, generate instructions based on the analyzed information, and transmit the generated instructions to work devices 100 by using the communication unit 201. The generated instructions comprise instructions for controlling at least one of a priority order of works to be performed by work devices 100 and a working route of the work devices 100. In some embodiments, the generated instructions are broadcasted to the work devices 100 located in the warehouse based on a need for a universal control of the work devices 100. In some other embodiments, the generated instructions are transmitted to a particular work device 100 based on a need for a specific control of the particular work device 100.

In some embodiments, the processor 203 is configured to identify a dimension and weight of a respective item located in the warehouse, by analyzing the information received from the work devices 100.

In some embodiments, the processor 203 is configured to determine the working route based on interference between the work devices and based on a floorplan of the warehouse.

In some embodiments, the processor 203 is configured to receive, from the work devices 100 that detect an accident, accident information, and modify the generated instruction based on the reported accident information. The processor 203 may transmit the modified instructions to the work devices 100.

A display 204 is also included in the warehouse management device 200. The display 204 may include an output means such as a display module, a speaker module, or a haptic module. The display may be provided in any form, for example, a plasma display panel (PDP), a liquid crystal display (LCD), a thin film transistor LCD (TFT LCD), an organic light emitting diode (OLED), a flexible display, a three-dimensional (3D) display, or an electronic-link (e-link) display.

In some embodiments, the display 204 displays working status of the warehouse based on the information analyzed by the processor 203.

In some embodiments, the display 204 displays utilization rate of a respective work device based on the information analyzed by the processor 203.

The various distinctive characteristics and technological ideas, described with reference to FIG. 2, can be realized as being in the form of software, hardware, firmware, middleware or a combination of them. For example, a program for realizing a method for managing a warehouse, which is stored in a computer-readable medium (which is executed by a computer or a controller including a processor), includes one or more program codes and sections that perform various tasks. The program codes executed by the processor 103.

In some embodiments, the warehouse management device 200 further includes an input device such as a keyboard, a mouse, a pen, a sound input device, a touch input device, etc., and output device(s) such as a display, speakers, a printer, etc.

In some embodiments, the input device may receive a user input to modify the generated instructions to be transmitted to the work devices 100.

In some embodiments, the warehouse management device 200 shown in FIG. 3 and described above may be an integral part of a control device or a control server. Alternatively, in some other embodiments, the warehouse management device 200 shown in FIG. 4 and described above may be a detachable part to the control device or the control server. For example, warehouse management device 200 may be a smart device (e.g., smartphone) including the communication unit 201, the memory 202, the processor 203, and the display 205, and configured to be coupled with the control device or the control server so that the control device or the control server may perform the operations described in the present disclosure.

FIG. 5 is a schematic figure illustrating a sensor of a work device according to some embodiments of the present disclosure.

In some embodiments, the sensor 104 of the work device may be configured as a sensing module as shown in FIG. 5. Thus, the sensor 500 may include a variety types of cameras and sensors. For example, as shown in FIG. 5, the sensor 104 includes a pair of monochrome stereo cameras 501 and 502, a RGB camera 504 for perception, an Inertial Measurement Unit (IMU) motion sensor 505, and an edge computing localization processor. In some other embodiments, a sensor 104 may include some of the elements shown in FIG. 5.

According to the above configuration of the variety types of cameras and sensors, the sensor 104 may collect a variety type of sensing data. Further, based on the variety type of sensing data, by using the edge computing localization processor 503, the sensor 104 more accurately identify items located in a warehouse. Thus, it may increase accuracy and efficiency of warehouse controlling.

Further, the sensor 104 may have a compact size. For example, the sensor 104 has 50 mm of height, 50 mm of width, and 200 mm of length. In some other embodiments, the sensor 104 may have a different compact size. According to those compact sizes, the sensor 104 is able to more conveniently combined with, attached to, or included in a work vehicle.

With the above configuration of the variety types of cameras and sensors, the warehouse management system may use computer vision technology and sensors included in the work devices 100, to track real time locations of mobile assets (i.e., the work devices 100) inside a warehouse. There is no additional sensor beacons required to make efficient controls of the work devices 100.

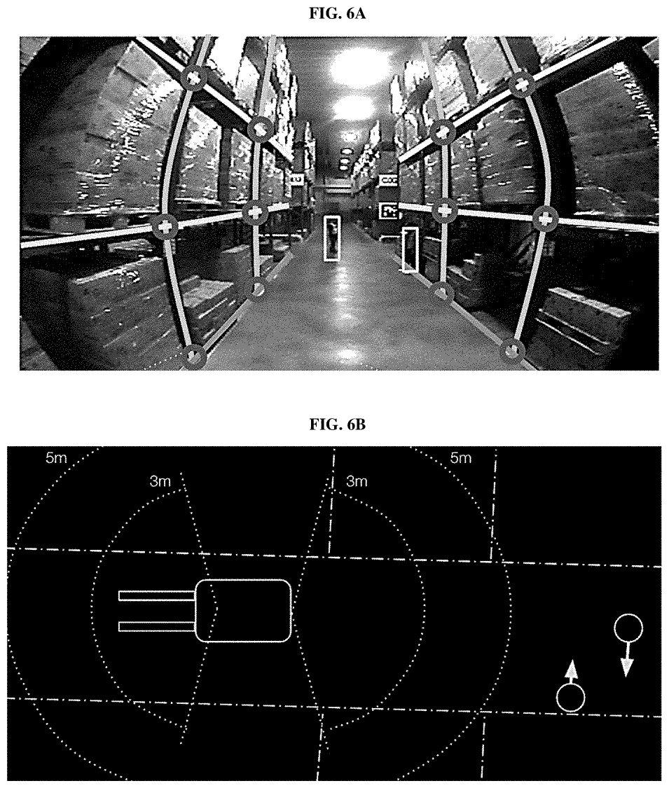

FIGS. 6A and 6B are schematic figures illustrating recognitions of objects from images according to some embodiments of the present disclosure.

As shown in FIG. 6A, from a video stream captured by a camera equipped with a work device, dynamic obstacles and 3D layout of a warehouse can be identified. The identified obstacles and 3D layout can be uses as warehouse information.

Further, in some embodiments, the identified obstacles and 3D layout can be simplified as shown in FIG. 6B, and recognized by a warehouse management device, to identify surrounding environments of a work device and to estimate safety conditions. These recognized information may be used to improve accuracy and efficiency of a warehouse management method.

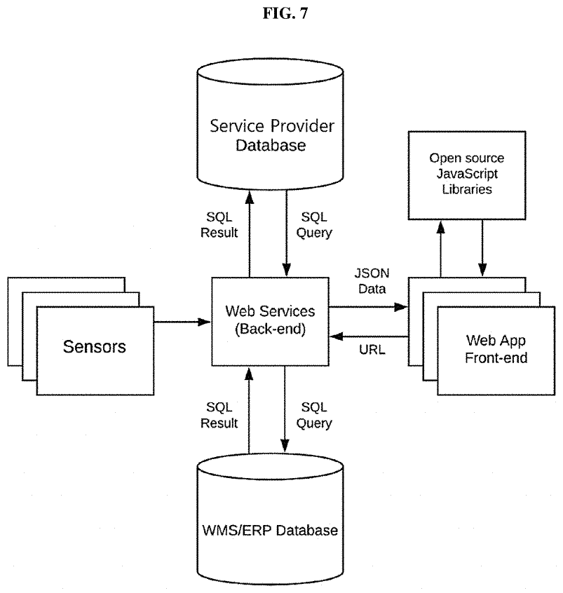

FIG. 7 is a schematic overview diagram illustrating data exchanges in a warehouse management system according to some embodiments of the present disclosure.

The web architecture diagram shown in FIG. 7 indicates flows of information. For example, the warehouse management method may be provided as a web-based service, and in an environment providing the web-based warehouse management service, sensors collect warehouse information and transmit the collected information to web services (back-end servers). The web services may communicate with a Warehouse Management System (WMS)/Enterprise Resource Planning (ERP) database, and also with a service provider database. In order to perform such communications, the web services may transmit a SQL query to the WMS/ERP database and receive a SQL result from the WMS/ERP database. Also, the service provider database may transmit a SQL query to the web services and receive a SQL result from the web services.

Further, the web services may transmit JSON data to a web app front-end and receive a URL from the web app front-end. The web app front-end may communicate with open source JavaScript libraries to provide web-based services.

The above-described flows of data are exemplarily embodiments according to the present disclosure. It should be understood that different flows of data are also available as long as a warehouse management service is properly provided.

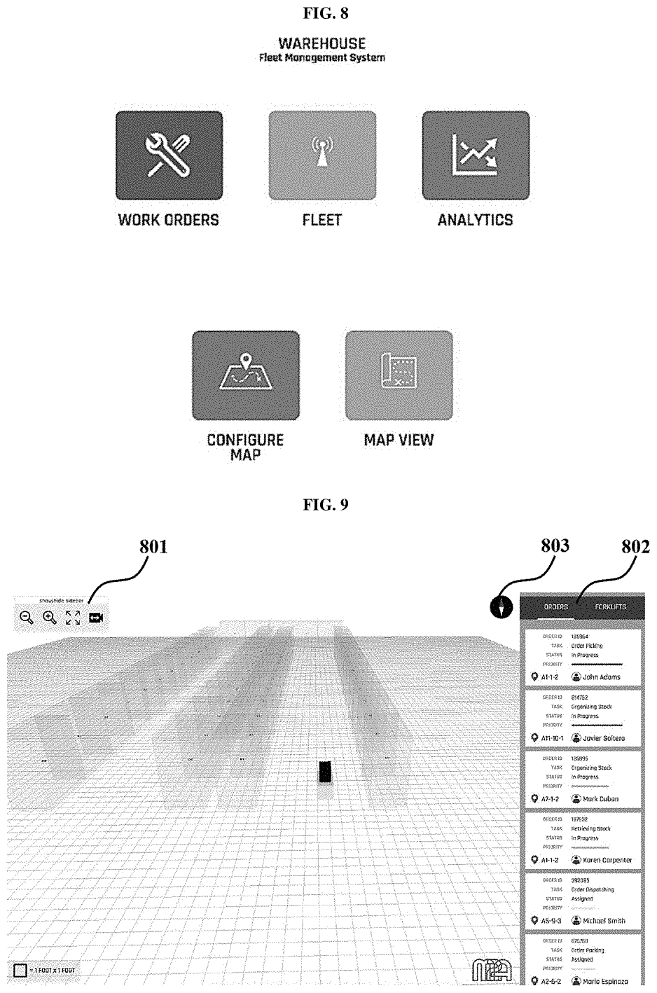

FIG. 8 is a schematic user interface of an initial menu of a warehouse management application according to some embodiments of the present disclosure.

In some example implementations of the present disclosure, a user interface (UI) shown in FIG. 8 may be provided to a user. The UI shown in FIG. 8 is the initial menu of the application (i.e., landing page), where a user can access different parts of the application.

The UI, which is a frontend user interface, may be built with React.js using Flux architecture. Redux can be used for state management. Webpack can also be used to bundle dependencies and build the code before serving to the browser. Mapped component is built using three.js, which is a JavaScript 3D library.

As shown in FIG. 8, the UI may include “WORK ORDERS” icon to show work orders in a warehouse, “FLEET” icon to show a 3D-mapped version of the warehouse, “ANALYTICS” icon to check work status (e.g., efficiency) of the warehouse, “CONFIGURATION MAP” icon to configure a map of the warehouse, and “MAP VIEW” to check the map of the warehouse.

According to some other example implementations of the present disclosure, some of the above icons may be shown in the UI, or some more additional icons may be shown in the UI.

FIGS. 9-17 are schematic user interfaces of a warehouse management application according to some embodiments of the present disclosure.

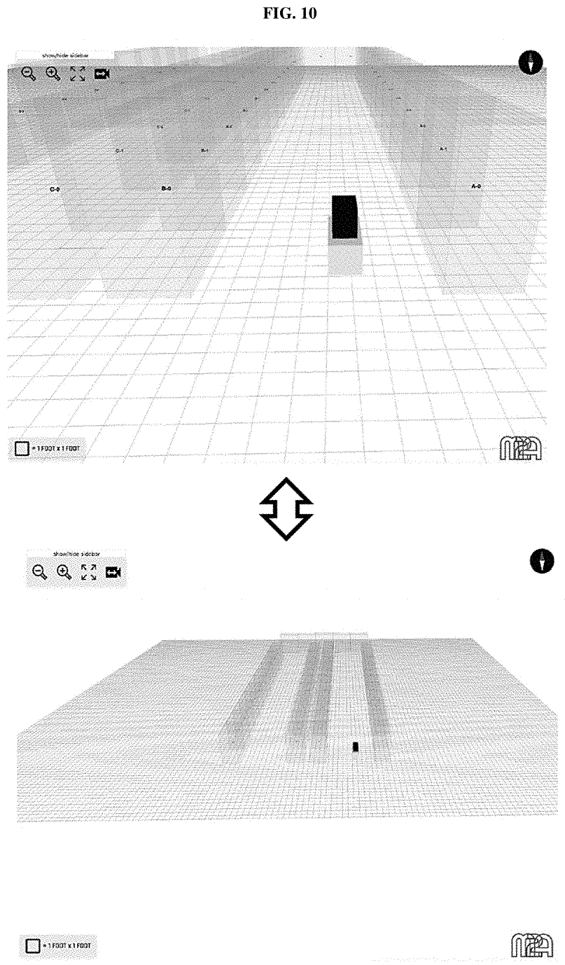

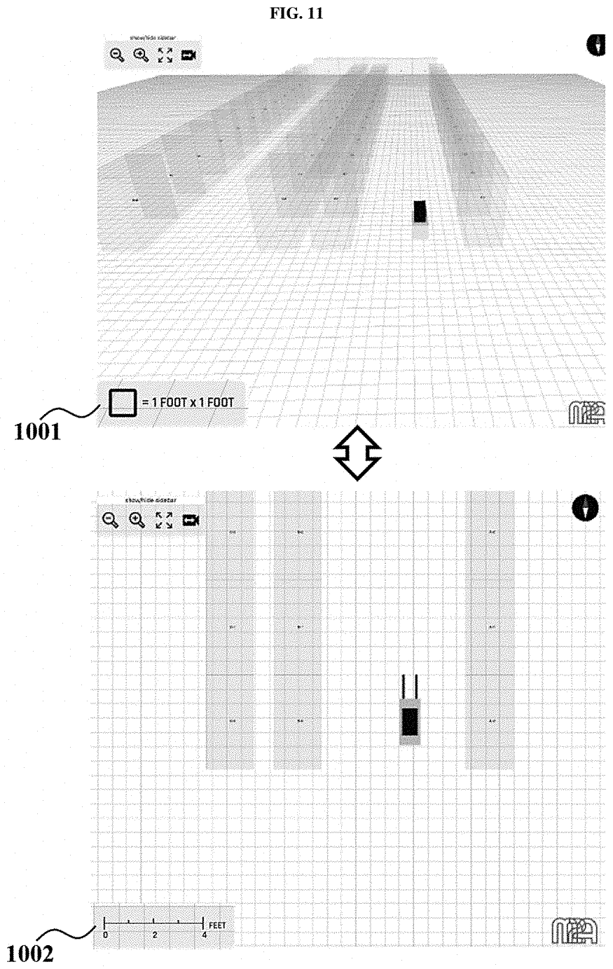

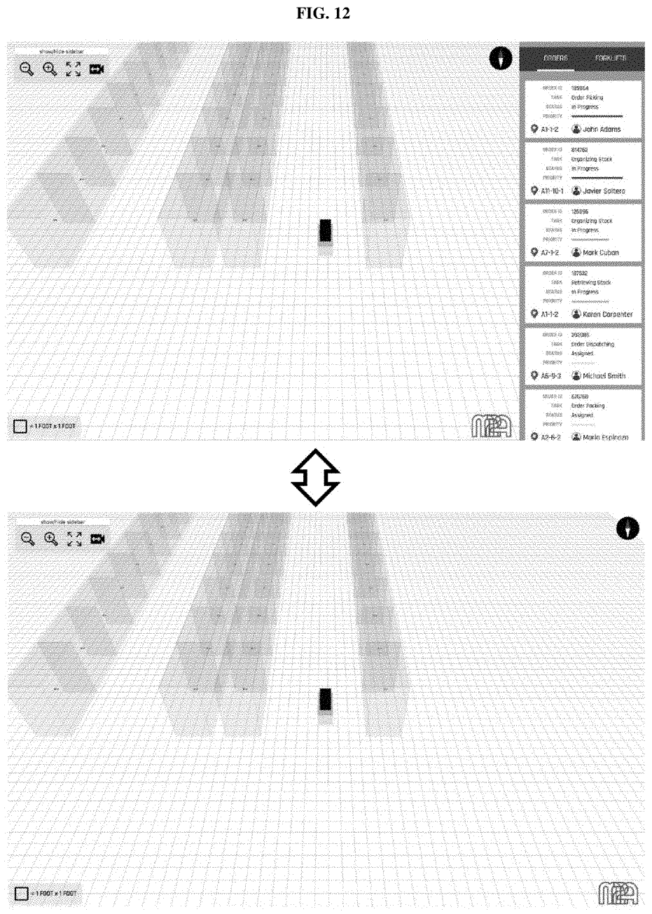

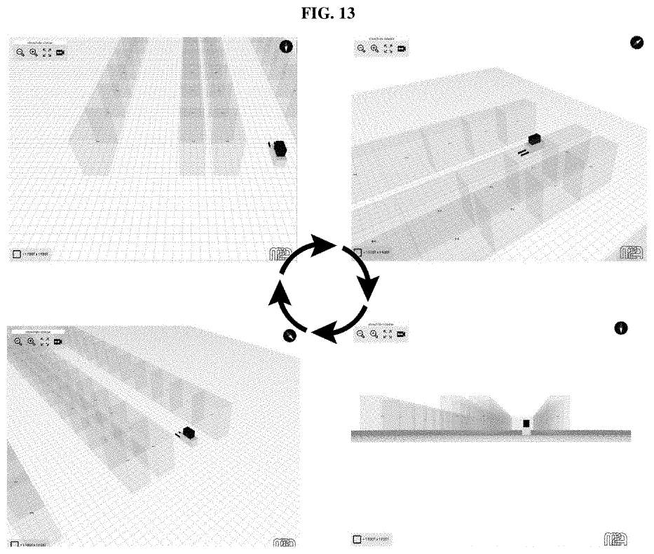

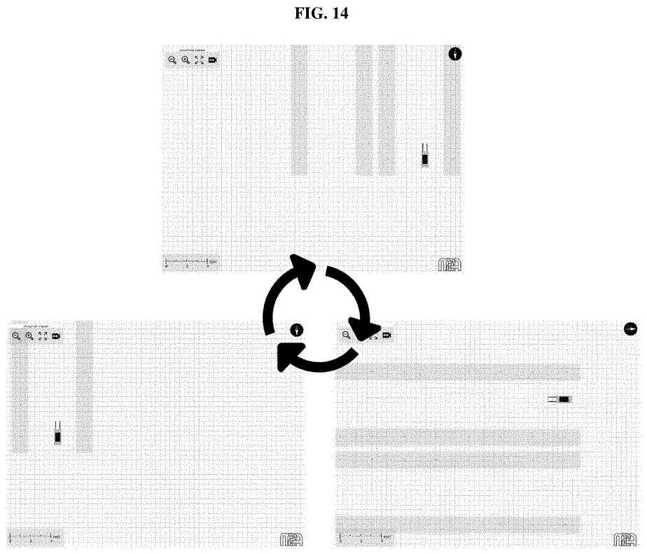

FIGS. 9-13 shows user interfaces with showing maps of a warehouse. As shown in FIG. 9, a control panel 801 and a sidebar 802 may be displayed on a user interface of the warehouse management application. The control panel 801 gives a user an option to change a camera zoom (in & out), to reset the camera to an original starting point, to change camera viewing type between perspective (3D) and orthographic (2D), and to visibility of the sidebar. With reference to figures, FIG. 10 shows changing the camera zoom (in & out), FIG. 11 shows changing camera viewing type between 3D and 2D, and FIG. 12 shows changing visibility of the sidebar. In some embodiments, a camera view point can be rotated in a variety ways, either in 3D viewing type, as shown in FIG. 13, or in 2D viewing type, as shown in FIG. 14.

The user interface may also include a compass 803 continues to point north in consideration of any camera rotations. Further, the user interface may include a scale 1001 for distance complements in 3D viewing type, or may include a scale 1002 for distance complements in 2D viewing type.

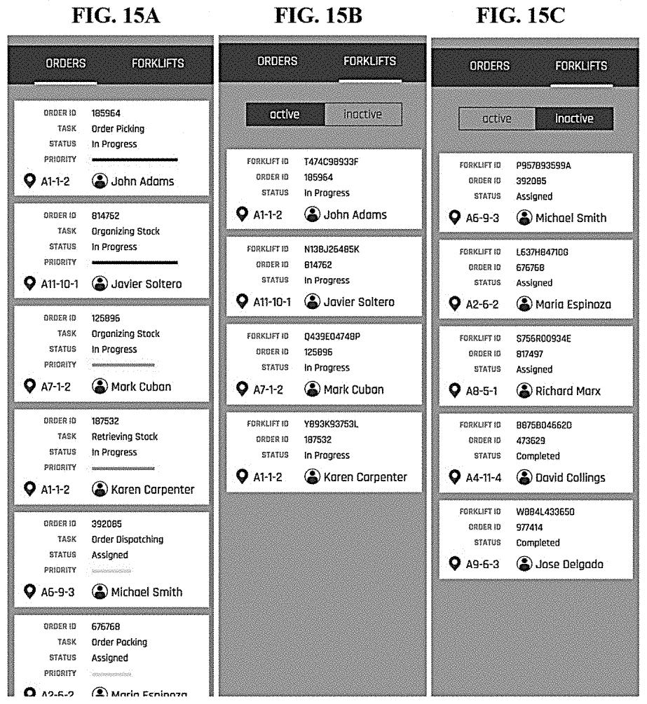

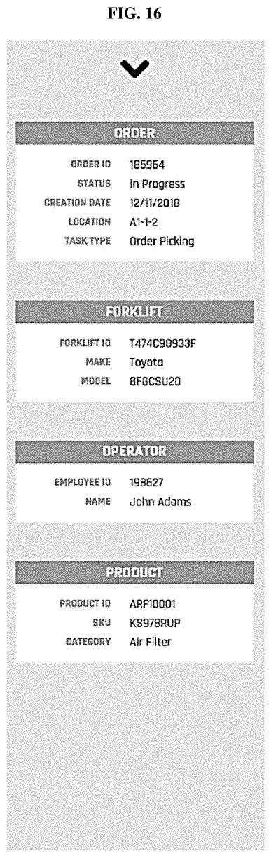

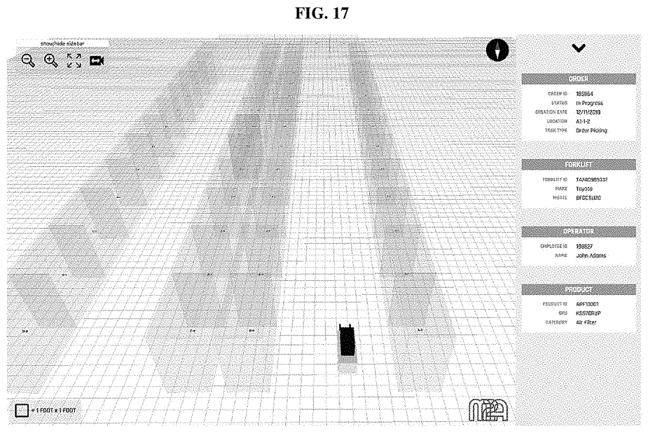

FIGS. 15A-17 are schematic user interfaces of the sidebar. As shown in FIGS. 15A-15C, the sidebar may display a filtered set of work orders. Filters are customizable to the user. As shown in FIG. 16, each work order card can be clicked to display another panel that provides more details pertaining to the particular work order. As shown in FIG. 17, the details of the work order shown in sidebar may be displayed with a 3D map.

Further, as shown in FIG. 17, the 3D map displays attributes such as, and not limited to, a highlighted start and end position pertaining to the selected work order.

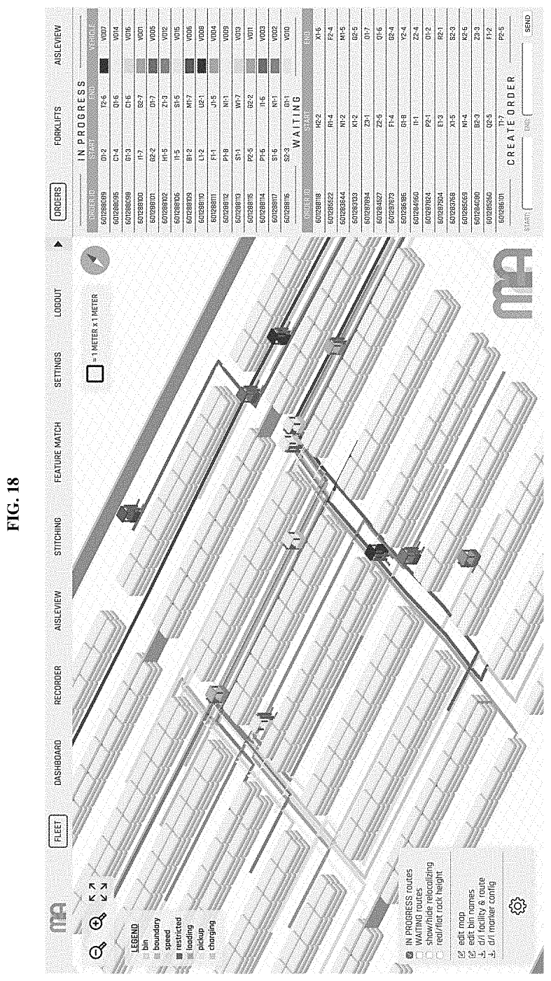

FIGS. 18-23 are schematic user interfaces of a warehouse management application according to some embodiments of the present disclosure.

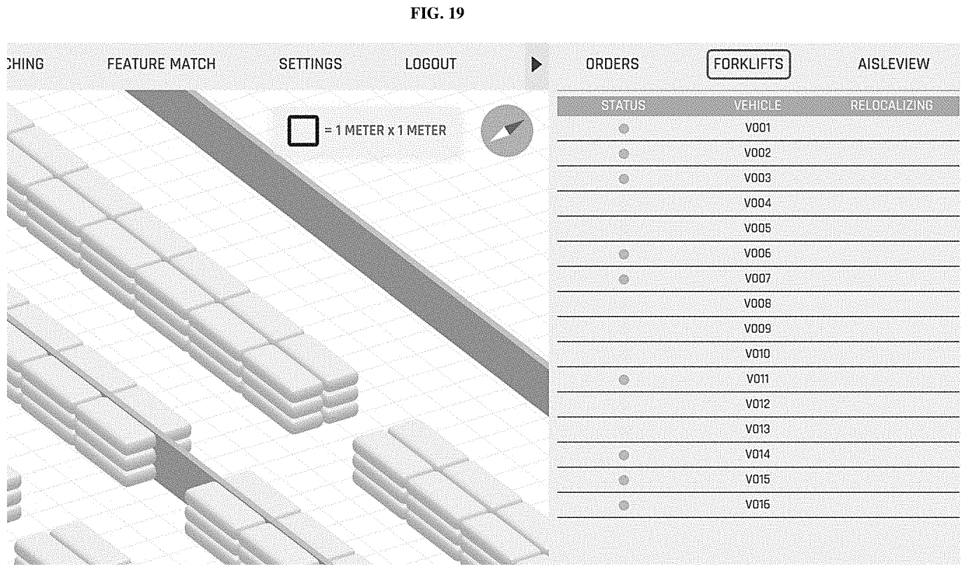

As shown in FIG. 18, more detailed information can be provided through the user interface. For example, locations of work devices, in real-time, can be shown in a map, a particular color can be assigned to a respective work device so that a user can more easily recognize works and status of each work device. The user interface may also include menu items for managing a warehouse. Further, as shown in FIG. 19, a status (e.g., utilization level) of each work device can be stated by using a particular color. Thus, the user may more easily check utilization levels of work devices.

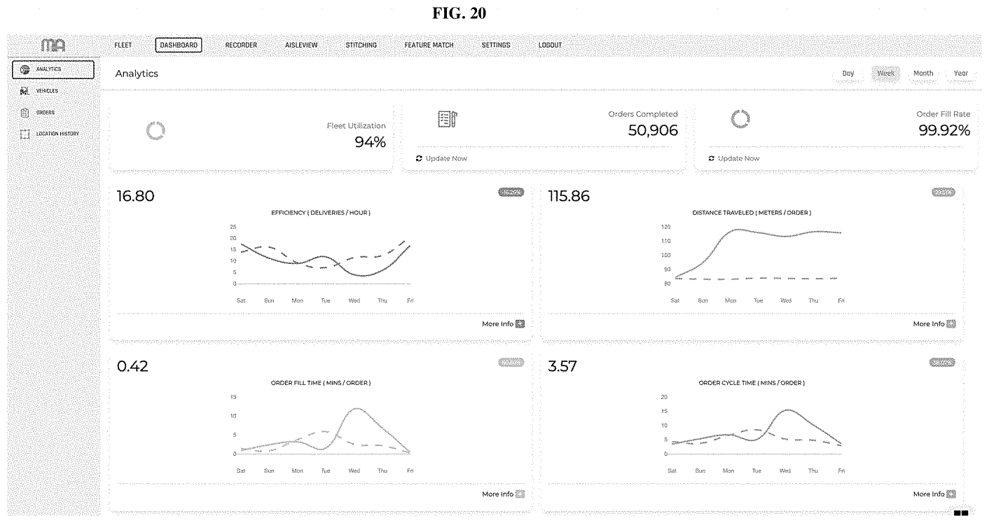

The warehouse management system may provide users with detailed information that can be used to manage a warehouse. For example, as shown in FIG. 20, a real-time dashboard can be provided. In the dashboard, the overall work device utilization level, the number of completed work orders, the overall work order utilization level, changes of efficiency, traveled distances, order fill time, and order cycle time can be visually displayed on the user interface.

Among the numbers included in the dashboard shown in FIG. 20, the utilization level can be calculated by using the following equation:

$$Utilization Level = \frac{ \begin{matrix}Total number of vehicles running \\ fater than a velocity threahold ( e . g . , 1 m \text{/} s )\end{matrix}}{Total number of vehicles}$$

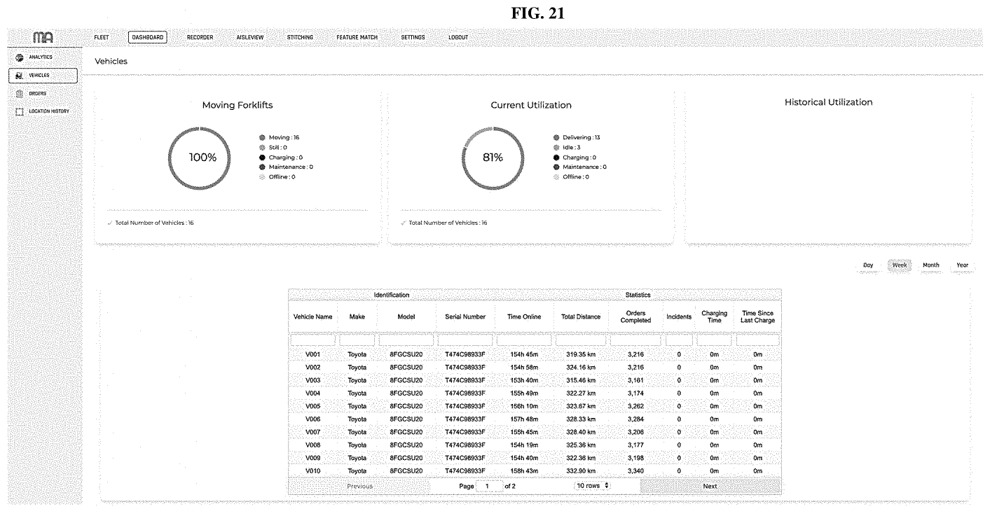

As another example, as shown in FIG. 21, information on how many work devices are moving, and detailed work device utilization information can be visually displayed on the user interface.

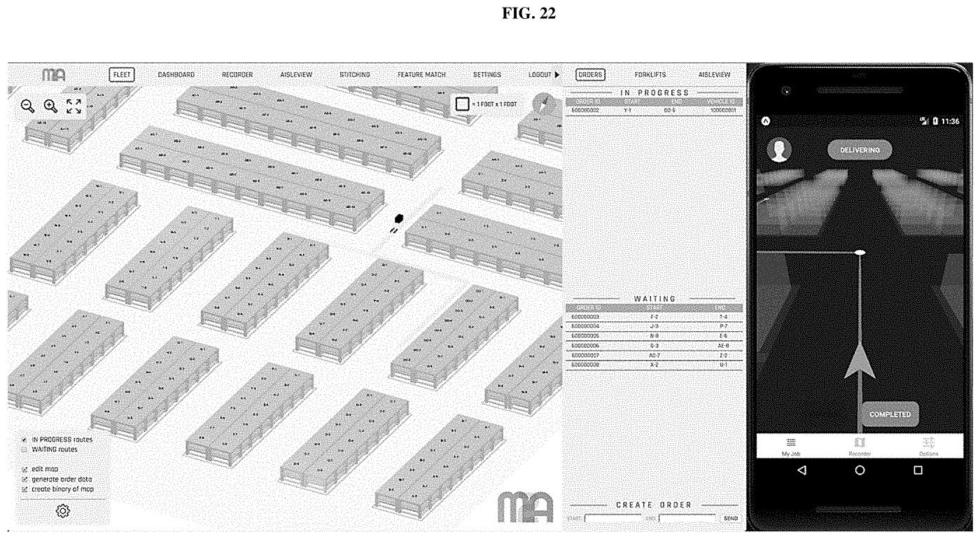

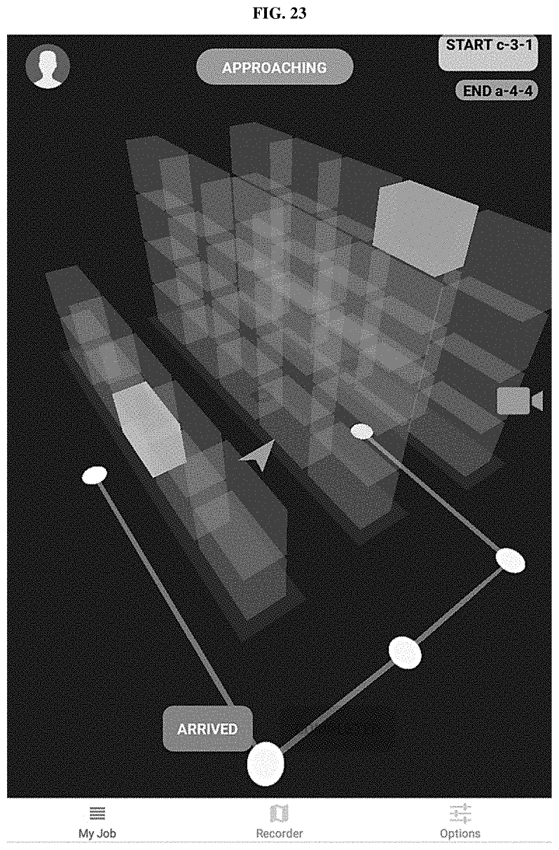

Further, as shown in FIG. 22, in the user interface, real-time mobile 3D navigation can be displayed with the map. The navigation navigates a work device to use a particular route to a designated work location. As shown in FIG. 23, the real-time mobile 3D navigation can also display a loading instruction and an unloading instruction.

According to features described with reference to the figures, managers of the warehouse management system are able to track the movement of the mobile assets. This capability provides managers with a complete overview of their operation, allowing them to monitor and improve the utilization rate of their mobile assets as well as to track and better manage their warehouse workers.

Moreover, using direct integration with the Enterprise Resource Planning (ERP) and Warehouse Management System (WMS) described above, work device operators are able to access work orders assigned to them on a mobile app installed in the work device. Once a work order is selected, operators can choose to start indoor navigation capability just like Google map, to get from their current physical location to the destination storage location. Once a job is completed, e.g., an item is picked and scanned using RF scanners and the status is updated in the WMS/ERP system, the warehouse management system gets updated to show the work order status. This allows managers to see status of ERP/WMS work orders at one location.

The operations of the method or algorithm described in connection with an embodiment of the inventive concept may be implemented directly in hardware, in a software module executed by hardware, or by a combination thereof. The software module may reside in a memory. The memory is, for example, a random access memory (RAM), read only memory (ROM), erasable programmable ROM (EPROM), electrically erasable programmable ROM (EEPROM), flash memory, hard disk, a removable disk, CD-ROM, or any form of computer readable recording medium well known in the art.

According to the inventive concept, as quantitative surrogate markers of indexes on myocardial contractile force and vascular resistance, the maximum amplitude of the first heart sound and the maximum amplitude of the second heart sound are obtained from the heart sound of a patient, and the change amounts of indexes on myocardial contractile force and vascular resistance are estimated based on the change amounts of the maximum amplitudes of the first and second heart sounds, so that, without using invasive arterial pressure measuring equipment and the like, through non-invasive test methods, the cardiovascular function of a patient may be estimated quickly, easily and precisely, and the cause of a blood pressure change may be determined based on at least one effect of alpha action, alpha blockage, beta action or beta blockage.

Effects of the present disclosure may not be limited to the above, and other effects of the present disclosure will be clearly understandable to those having ordinary skill in the art from the disclosures provided below together with accompanying drawings.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. A method for managing a warehouse, performed by a system including a plurality of sensors, the method comprising:
collecting information on the warehouse;
analyzing the collected information;
generating instructions based on the analyzed information;
transmitting the generated instructions to work devices,
wherein the generated instructions comprise
instructions for controlling at least one of a priority order of works to be performed by the work devices and a working route of the work devices in the warehouse.

2. The method according to claim 1,
wherein the generating instructions comprises
combining the analyzed information with work information received from an external device; and
generating the instructions based on the combined information.

3. The method according to claim 1,
wherein the collecting information comprises
collecting image information by using an image sensor included in a respective work device.

4. The method according to claim 1,
wherein the analyzing the collected information comprises
identifying a dimension and weight of a respective item located in the warehouse.

5. The method according to claim 1,
wherein the working route is determined based on a potential interference between the work devices and based on a floorplan of the warehouse.

6. The method according to claim 1, further comprising:
reporting, by the work devices that detect an accident, accident information to a control device; and
modifying, by the control device, the generated instruction based on the reported accident information.

7. The method according to claim 1, further comprising:
displaying, at a respective work device, navigation information including route information and working order information, based on the generated instructions.

8. The method according to claim 1, further comprising:
displaying, at a control device, a utilization rate of a respective work device.

9. A control device comprising:
a processor and a memory coupled with the processor,
wherein the processor is configured to
collect information on the warehouse;
analyze the collected information;
generate instructions based on the analyzed information;
transmit the generated instructions to work devices,
wherein the generated instructions comprise
instructions for controlling at least one of a priority order of works to be performed by work devices and a working route of the work devices.

10. The control device according to claim 8, wherein the processor is further configured to combine the analyzed information with work information received from an external device, and generate the instructions based on the combined information.

11. The control device according to claim 9,
wherein the collected information comprises
image information collected by an image sensor included in a respective work device.

12. The control device according to claim 9,
wherein the processor is configured to identify a dimension and weight of a respective item located in the warehouse.

13. The control device according to claim 12,
wherein the processor is further configured to determine the working route based on interference between the work devices and based on a floorplan of the warehouse.

14. The control device according to claim 9,
wherein the processor is configured to
receive, from the work devices that detect an accident, accident information, and
modify the generated instruction based on the reported accident information.

15. The control device according to claim 9, further comprising:
a display that display working status of the warehouse based on the analyzed information, wherein the working status includes a utilization rate of a respective work device.

16. A work device comprising:
a processor and a memory coupled with the processor,
wherein the processor is configured to
collect information on the warehouse;
transmit the collected information to a control system;
receive instructions from the control system; and
execute the received instructions,
wherein the received instructions comprise
instructions for controlling at least one of a priority order of works to be performed by the work device and a working route of the work device.

17. The work device according to claim 16, further comprising:
at least one sensor that performs sensing to collect the information on the warehouse.

18. The work device according to claim 17,
wherein the at least one sensor comprises an image sensor that collects image information on the warehouse.

19. The work device according to claim 16,
wherein the processor is further configured to
detect an accident,
report accident information to a control device, and
receive modified instructions from the control device.

20. The work device according to claim 16, further comprising:
a display configured to display navigation information including route information and working order information, based on the received instructions.
